(19) United States
(12) Patent Application Publication
(10) Pub. No.: US 2006/0078276 A1
(43) Pub. Date: Apr. 13, 2006

(54) Optical disk recording and reproducing apparatus

(75) Inventor: Katsuo Tokuhara, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/227,237

(22) Filed: Sep. 16, 2005

(30) Foreign Application Priority Data
Sep. 28, 2004 (JP) P2004-281231

(51) Int. Cl. H04N 5/91

(52) U.S. Cl. 386/46

(57) ABSTRACT

When an input video signal is not present, a signal presence/absence deciding unit decides that the input video signal is not present. A switch unit is switched to an output side of a flash memory in response thereto. Then, fixed image data from the flash memory 18 is supplied to an MPEG 2 encoder. Compressed fixed video data outputted from the MPEG 2 encoder is recorded on an optical disk. That is, when there is no input video signal, a fixed image is recorded on the optical disk in place of a noise image. Accordingly, even when the optical disk 15 is reproduced, the noise image is not outputted and the fixed image is outputted instead thereof.

### BACKGROUND OF THE INVENTION

1. Field of the Invention

The present invention relates to an optical disk recording and reproducing apparatus such as a DVD (Digital Versatile Disk) recorder for recording/reproducing information on an optical disk, and more particularly to a video switching process carried out when there is no input video signal upon recording information.

2. Description of the Related Art

FIG. 5 is a block diagram showing the structure of a usual optical disk recording and reproducing apparatus. The optical disk recording and reproducing apparatus includes a video decoder 5 for decoding an analog video signal inputted from a tuner that is not shown in the drawing to convert the analog video signal to a digital video signal, an MPEG 2 encoder 7 as a video encoder for encoding the digital video signal from the video decoder 5 by an MPEG 2 (Moving Picture Experts Group 2) system, an audio A/D converting circuit 6 for converting an analog audio signal inputted from the tuner to a digital audio signal and an audio processing circuit 8 including an audio buffer circuit and a compressing circuit for buffering and compressing the digital audio signal from the audio A/D converting circuit 6 to output compressed audio data.

Further, the optical disk recording and reproducing apparatus includes an MPEG 2 decoder 9 for decoding compressed video data inputted upon reproduction in accordance with the MPEG 2 system, a video encoder 11 for encoding a digital video signal from the MPEG2 decoder 9 to convert the digital video signal to an analog video signal and output the analog video signal, an audio processing circuit 10 including an expanding circuit and an audio buffer circuit for expanding and buffering and outputting digital audio data inputted upon reproduction, and an audio D/A converting circuit 12 for converting a digital audio signal from the audio processing circuit 10 to an analog audio signal and outputting the analog audio signal.

Further, the optical disk recording and reproducing apparatus includes a stream controller 13 for transmitting an output signal of the MPEG 2 encoder 7 and an output signal of the audio processing circuit 8 to a front end (loader) 14 or transmitting an output signal from the front end 14 to the MPEG 2 decoder 9 and the audio processing circuit 10 and a system controller 16 including a CPU to control the entire part of the apparatus.

The video decoder 5 and the audio A/D converting circuit 6 are included in a first signal processing circuit 1. The MPEG 2 encoder 7 and the audio processing circuit 8 are included in a second signal processing circuit 2. Further, the MPEG 2 decoder 9 and the audio processing circuit 10 are included in a third signal processing circuit 3. The video encoder 11 and the audio D/A converting circuit 12 are included in a fourth signal processing circuit 4. The first signal processing circuit 1 and the second signal processing circuit 2 are processing circuits of a recording system. The third signal processing circuit 3 and the fourth signal processing circuit 4 are processing circuits of a reproducing system.

Now, a video switching process of the usual optical disk recording and reproducing apparatus will be described below. By referring to this flowchart, in the usual optical disk recording and reproducing apparatus, the video switching process when video and audio information is recorded will be described.

For instance, an optical disk 15 is prepared to record a television broadcast program and the optical disk 15 is inserted into the optical disk recording and reproducing apparatus. Then, when the optical disk recording and reproducing apparatus is set to a recording mode (image recording mode), a video signal and an audio signal of the television broadcast program desired to be recorded are outputted from a tuner (not shown in the drawing) in the optical disk recording and reproducing apparatus or an external output terminal (not shown in the drawing) of a television receiver and respectively inputted to the video decoder 5 and the audio A/D converting circuit 6.

Then, the digital video signal from the video decoder 5 is inputted to the MPEG 2 encoder 7 and encoded in accordance with the MPEG 2 system. The digital audio signal from the audio A/D converting circuit 6 is inputted to the audio processing circuit 8 and compressed. The compressed video data from the MPEG 2 encoder 7 and the compressed audio data from the audio processing circuit 8 become compressed video and audio data through the stream controller 13. The compressed vide and audio data is inputted to the front end 14. Thus, the front end 14 drives an optical pick-up that is not shown in the drawing to record the compressed vide and audio data on the optical disk 15.

When the video and audio data recorded on the optical disk 15 is reproduced, the optical disk recording and reproducing apparatus is set to a reproducing mode to start a reproducing operation. Then, the front end 14 reads the compressed video and audio data from the optical disk 15 by the optical pick-up and inputted to the stream controller 13. Then, the stream controller 13 separates the inputted compressed video and audio data to the compressed video data and the compressed audio data to input the compressed video data to the MPEG 2 decoder 9 and the compressed audio data to the audio processing circuit 10.

The MPEG 2 decoder 9 decodes the compressed video data from the stream controller 13 in accordance with the MPEG 2 system to input the decoded video data to the video encoder 11 as the digital video signal. Thus, the video encoder 11 encodes the digital video signal to output the analog video signal. The analog video signal is supplied to a display device of a television that is not shown in the drawing, so that an image thereof is displayed on the display device.

The audio processing circuit 10 expands the compressed audio data from the stream controller 13 to input the expanded audio data to the audio D/A converting circuit 12 as the digital audio signal. Thus, the audio D/A converting circuit 12 D/A converts the digital audio signal to output the analog audio signal. The analog audio signal is supplied to an audio circuit of the television that is not shown in the drawing, so that a sound thereof is outputted from a speaker.

### SUMMARY OF THE INVENTION

While a television program is recorded by using the usual optical disk recording and reproducing apparatus having the above-described structure, for instance, when an antenna is pulled out so that there is no channel input (input video signal), ablue screen appears on the display device of the television. However, a video signal in the blue screen has only noise. Since a noise image is also treated as the video signal, the video signal recorded on the optical disk at this time corresponds to the noise and the noise image is recorded on the optical disk.

Accordingly, when the optical disk on which such a noise image is recorded is reproduced in other DVD player, a DVD recorder or the like, since the noise image appears in a part where the input video signal is not present, an uncomfortable feeling is given to a viewer. Further, since the noise image has high frequency, the noise image requires many recording bits so that the recording efficiency of the optical disk is apt to be deteriorated.

In JP-A-2004-147204, thumbnail data that can refer to content data is formed by the video information of a main part of automatically discriminated content data. However, a countermeasure for preventing the noise image from appearing when there is no input video signal is not provided.

JP-A-2002-281452 and JP-A-2003-46944 concern a magnetic recording and reproducing device and does not concern the optical disk recording and reproducing apparatus.

According to JP-A-2002-218331, when a non-signal state of video or audio is detected, an image file or an audio file previously recorded in a hard disk or a card type recording medium by a user is read, reproduced and outputted, so that a slide show of a still image or a BGM music can be looked or listened to in place of a sand storm screen, a completely blue screen or a completely black screen, or noise. When noise is recorded on a recording medium, a display side manages so that the noise does not appear. For instance, when a case is assumed that the optical disk such as aDVDis used as the recording medium, the noise is recorded on the optical disk. Thus, when the optical disk is reproduced by other reproducing apparatus, the noise appears on a display screen.

It is an object of the present invention to provide an optical disk recording and reproducing apparatus in which a noise image is not recorded when there is no input video signal upon recording information on an optical disk, and a fixed image can be recorded in place thereof.

According to an aspect of the invention, there is provided with an optical disk recording and reproducing apparatus having: a video decoder for decoding an inputted analog video signal to convert the analog video signal to a digital video signal; and a video encoder for encoding the digital video signal from the video decoder in a prescribed compressing and encoding system and outputting video data compressed for recording to record/reproduce information on an optical disk, the apparatus including: a flash memory previously storing fixed video data; a switch unit selecting either one of an output of the video decoder and an output of the flash memory, the switch unit inputting the selected output to the video encoder; a signal presence/absence deciding unit deciding whether or not an input video signal is present upon recording process, and a switch driving unit driving the switch unit to select the output of the video decoder when the signal presence/absence deciding unit decides that the input video signal is present, and the switching driving unit driving the switch unit to select the output of the flash memory when the signal presence/absence deciding unit decides that the input video signal is not present, wherein the fixed video data from the flash memory is recorded on the optical disk, when the input video signal is not present. The fixed video data is recorded only on a VOBU in the head of a cell in accordance with a DVD video standard, when the fixed video data is recorded on the optical disk.

In this structure, when the signal presence/absence deciding unit decides that the input video signal is present upon recording process, the switch unit selects the output of the video decoder. Thus, the digital video signal from the video decoder is supplied to the video encoder and the compressed video data outputted from the video encoder is recorded on the optical disk.

Here, when there is no input video signal, the signal presence/absence deciding unit decides that the input video signal is not present. The switch unit is switched to an output side of the flash memory by the switch driving unit in response thereto. Then, the fixed video data from the flash memory is supplied to the video encoder and the compressed fixed data outputted from the video encoder is recorded on the optical disk. That is, a fixed image is recorded on the optical disk in place of a noise image when the input video image is not present. Accordingly, even when the optical disk is reproduced, the noise image is not outputted, and the fixed image is outputted in place thereof.

Further, when the fixed video data is recorded on the optical disk, if the fixed video data is recorded only on the VOBU in the head of the cell in accordance with the DVD video standard, audio data can be recorded for a long time and can be reproduced by a DVD player or the like.

According to this structure, when there is no input video signal upon recording information on the optical disk, the noise image is not recorded and the fixed image can be recorded instead thereof. Accordingly, even when the optical disk is reproduced, the noise image does not appear on a screen so that a user does not have an uneasy feeling. Further, since the fixed video is recorded in accordance with the DVD video standard, the optical disk can be reproduced by the DVD player and the optical disk can be used for an audio.

According to another aspect of the invention, there is provided with an optical disk recording and reproducing apparatus for recording/reproducing information on an optical disk, including: a flash memory previously storing fixed video data; a switch unit selecting and outputting any of a video signal obtained by processing an input video signal and the fixed video data from the flash memory; a signal presence/absence deciding unit deciding whether or not the input video signal is present upon recording process, and a switch driving unit driving the switch unit to select the output of the flash memory when the signal presence/absence deciding unit decides that the input video signal is not present. The fixed video data from the flash memory is recorded on the optical disk, when the input video signal is not present.

In this structure, when the signal presence/absence deciding unit decides that the input video signal is present upon recording process, the switch unit selects the input video signal to record video data by the input video signal on the optical disk.

Here, when there is no input video signal, the signal presence/absence deciding unit decides that the input video signal is not present. The switch unit is switched to an output side of the flash memory by the switch driving unit in response thereto. Then, the fixed video data from the flash memory is recorded on the optical disk. That is, a fixed image is recorded on the optical disk in place of a noise image when the input video image is not present. Accordingly, even when the optical disk is reproduced, the noise image does not appear on the screen and the fixed image is displayed in place thereof.

According to this structure, when there is no input video signal upon recording information on the optical disk, the noise image is not recorded and the fixed image can be recorded instead thereof. Accordingly, even when the optical disk is reproduced, the noise image does not appear on the screen so that the user does not have an uncomfortable feeling.

According to another aspect of the invention, the video signal obtained by processing the input video signal is a digital video signal obtained by decoding an inputted analog video signal by a video decoder. A signal outputted from the switch unit is supplied to a video encoder for encoding the digital video signal from the video decoder or the fixed video data from the flash memory in a prescribed compressing and encoding system and outputting video data compressed for recording.

According another aspect of the invention, when the fixed video data is recorded on the optical disk, the fixed video data is recorded only on a VOBU in a head of a cell in accordance with a DVD video standard.

According to the above-aspects, an optical disk recording and reproducing apparatus has a video decoder for decoding an inputted analog video signal to convert the analog video signal to a digital video signal and a video encoder for encoding the digital video signal from the video decoder in a prescribed compressing and encoding system and outputting video data compressed for recording to record/reproduce information on an optical disk. The optical disk recording and reproducing apparatus comprises: a flash memory for previously storing fixed video data; a switch unit for selecting an output of the video decoder or an output of the flash memory to input the output to the video encoder; a signal presence/absence deciding unit for deciding whether or not an input video signal is present upon recording process, and a switch driving unit for driving the switch unit to select the output of the video decoder when the signal presence/absence deciding unit decides that the input video signal is present, and driving the switch unit to select the output of the flash memory when the signal presence/absence deciding unit decides that the input video signal is not present. When the input video signal is not present, the fixed video data from the flash memory is recorded on the optical disk, and when the fixed video data is recorded on the optical disk, the fixed video data is recorded only on a VOBU in the head of a cell in accordance with a DVD video standard. According to this structure, when there is no input video signal upon recording information on the optical disk, the noise image is not recorded and the fixed image can be recorded instead thereof. Accordingly, even when the optical disk is reproduced, the noise image does not appear on the screen so that the user does not have an uncomfortable feeling. Further, since the fixed image is recorded in accordance with the DVD video standard, the optical disk can be reproduced by the DVD player or the like and the optical disk can be used for an audio.

According to the above-aspects, an optical disk recording and reproducing apparatus includes: a flash memory for previously storing fixed video data; a switch unit for selecting and outputting any of a video signal obtained by processing an input video signal and the fixed video data from the flash memory; a signal presence/absence deciding unit for deciding whether or not the input video signal is present upon recording process, and a switch driving unit for driving the switch unit to select the output of the flash memory when the signal presence/absence deciding unit decides that the input video signal is not present. When the input video signal is not present, the fixed video data from the flash memory is recorded on the optical disk. According to this structure, when there is no input video signal upon recording information on the optical disk, the noise image is not recorded and the fixed image can be recorded instead thereof. Accordingly, even when the optical disk is reproduced, the noise image does not appear on the screen so that the user does not have an uncomfortable feeling.

### BRIEF DESCRIPTION OF THE DRAWINGS

FIG. 1 is a block diagram showing the structure of an optical recording and reproducing apparatus according to an embodiment of the present invention.

FIG. 2 is a diagram showing a data structure of a VOB (video object) based on a DVD video standard in the embodiment.

FIG. 3 is a data structure diagram for explaining that fixed video data is recorded only in a head VOBU (video object unit) of a cell when the fixed video data from a flash memory is recording on an optical disk in the embodiment.

FIG. 4 is a flowchart for explaining a video switching process when video and audio information is recorded on the optical disk in the embodiment.

FIG. 5 is a block diagram showing the structure of a usual optical disk recording and reproducing apparatus.

### DESCRIPTION OF THE PREFERRED EMBODIMENTS

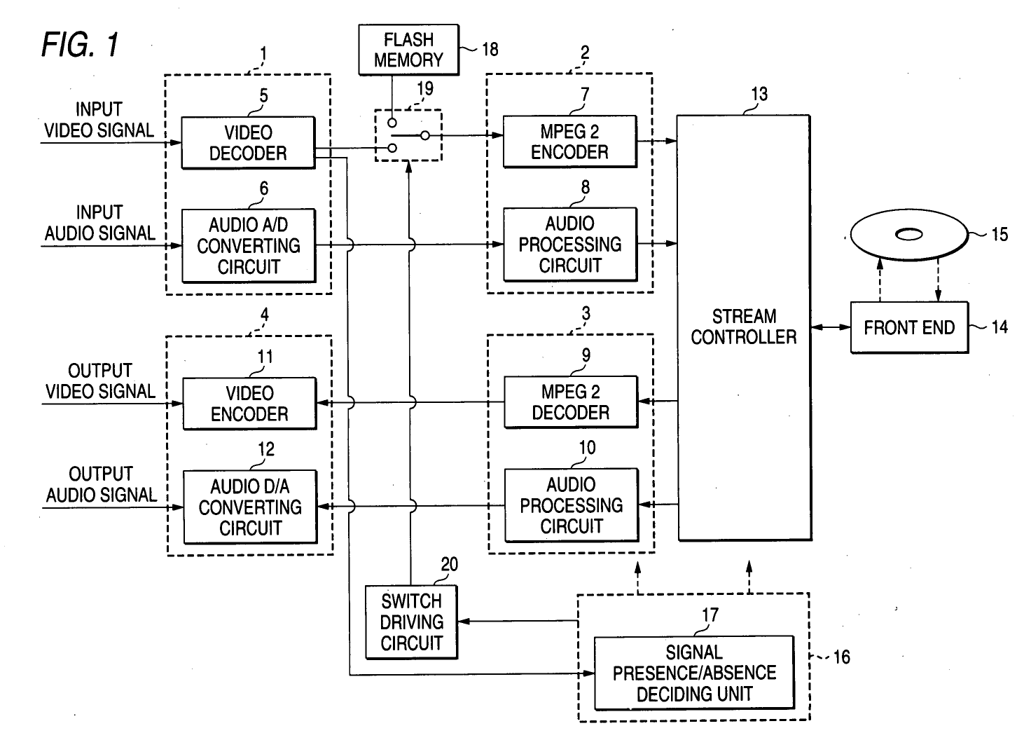

Now, referring to the accompanying drawings, an embodiment of the present invention will be described below. FIG. 1 is a block diagram showing the structure of an optical disk recording and reproducing apparatus according to an embodiment of the present invention.

The optical disk recording and reproducing apparatus includes a video decoder 5 for decoding an analog video signal inputted from a tuner that is not shown in the drawing to convert the analog video signal to a digital video signal, an MPEG 2 encoder 7 as a video encoder for encoding the digital video signal from the video decoder 5 in accordance with an MPEG 2 system, a flash memory 18 for previously storing fixed video data, a switch unit 19 for selecting an output of the video decoder 5 or an output of the flash memory 18 and inputting the output to the MPEG2 encoder 7, a signal presence/absence deciding unit 17 for deciding whether or not an input video signal is present upon recording process, and a switch driving circuit 20 for driving the switch unit 19 to select the output of the video decoder 5 when the signal presence/absence deciding unit decides that the input video signal is present, and driving the switch unit 19 to select the output of the flash memory 18 when the signal presence/absence deciding unit 17 decides that the input video signal is not present. The switch unit 19 has an electronic circuit.

Further, the optical disk recording and reproducing apparatus includes an audio A/D converting circuit 6 for converting an analog audio signal inputted from a tuner to a digital audio signal, an audio processing circuit 8 including an audio buffer circuit and a compressing circuit for buffering and compressing the digital audio signal from the audio A/D converting circuit 6, an MPEG 2 decoder 9 for decoding compressed video data inputted upon reproduction in accordance with the MPEG 2 system, a video encoder 11 for encoding a digital video signal from the MPEG 2 decoder 9 to convert the digital video signal to an analog video signal and output the analog video signal, an audio processing circuit 10 including an expanding circuit and an audio buffer circuit for expanding and buffering and outputting digital audio data inputted upon reproduction, and an audio D/A converting circuit 12 for converting a digital audio signal from the audio processing circuit 10 to an analog audio signal and outputting the analog audio signal.

Further, the optical disk recording and reproducing apparatus includes a stream controller 13 for transmitting an output signal of the MPEG 2 encoder 7 and an output signal of the audio processing circuit 8 including the audio buffer to a front end (loader) 14 or transmitting an output signal from the front end 14 to the MPEG 2 decoder 9 and the audio processing circuit 10 and a system controller 16 including a CPU that is not shown in the drawing to control the entire part of the apparatus. In this system controller 16, the above-described signal presence/absence deciding unit 17 is included. The front end 14 includes an optical pick-up that is not illustrated to write or read information on an optical disk 15.

The video decoder 5 and the audio A/D converting circuit 6 are included in a first signal processing circuit 1. The MPEG 2 encoder 7 and the audio processing circuit 8 are included in a second signal processing circuit 2. Further, the MPEG 2 decoder 9 and the audio processing circuit 10 are included in a third signal processing circuit 3. The video encoder 11 and the audio D/A converting circuit 12 are included in a fourth signal processing circuit 4. The first signal processing circuit 1 and the second signal processing circuit 2 are processing circuits of a recording system. The third signal processing circuit 3 and the fourth signal processing circuit 4 are processing circuits of a reproducing system.

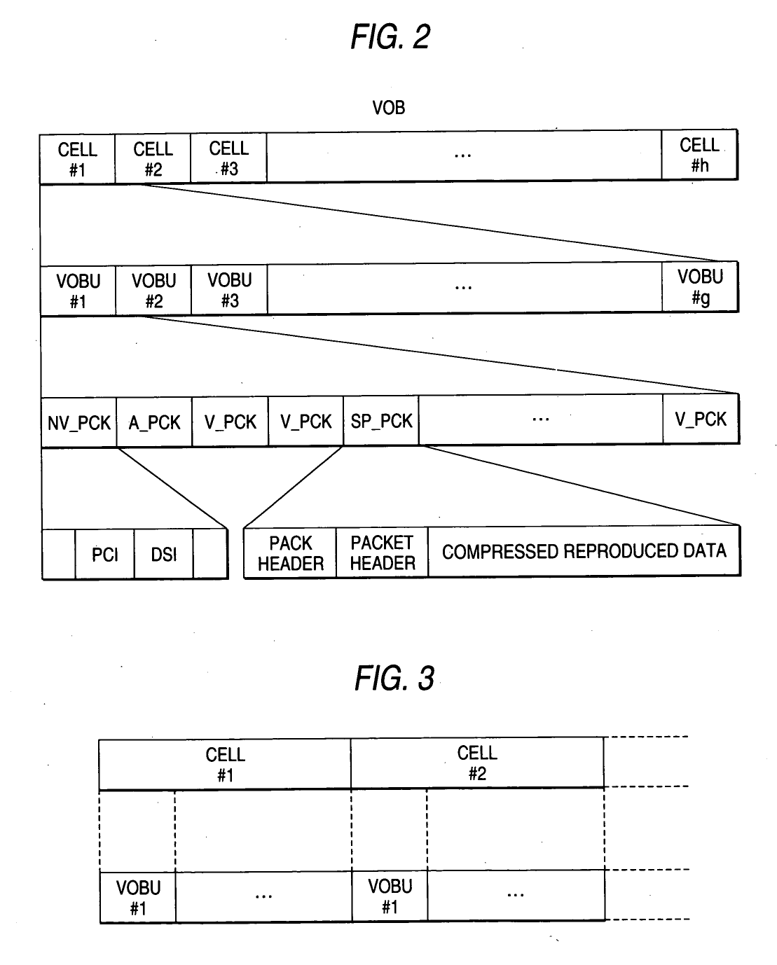

FIG. 2 is a diagram showing a data structure of a VOB (video object) based on a DVD video standard in this embodiment.

In FIG. 2, the VOB includes a plurality of cells and each cell includes a plurality of VOBUs (video object unit). Each VOBU (video object unit) includes at least one of NV-PCK (navigation pack), V-PCK (video pack), SP-PCK (sub-picture pack) and A-PCK (audio pack).

NV-PCK (navigation pack) information includes PCI (reproduction control information) and DSI (data search information). In the PCI (reproduction control information) and the DSI (data search information), information such as a quantity of data of the VOBU (video object unit), a reproducing time from the start of a reproduction of a title to the start of a reproduction of a corresponding VOBU (video object unit), a position of a VOBU (video object unit) to be subsequently reproduced is set. When the optical disk can be resumed and reproduced, resumable information for discriminating that a resume-reproduction can be performed is also included in the PCI (reproduction control information).

The V-PCK 8 video pack), the SP-PCK (sub-picture pack) and the A-PCK (audio pack) respectively include a pack header having information such as types of reproduced data (a moving image, a sub-picture, an audio), a packet header, compressed reproduced data with data compressed (video data, sub-picture data, audio data).

FIG. 3 is a data structure diagram for explaining that the fixed data is recorded only on a head VOBU (video object unit) of the cell when the fixed video data from the flash memory is recorded on the optical disk in this embodiment. The fixed video data is recorded respectivelyin, for instance, the headVOBU (videoobject unit) #1 of a cell #1 and in the head VOBU (video objet unit) #2 of a cell #2 as shown in FIG. 3. In the subsequent cells, the fixed data is likewise recorded in the head VOBUs (video object unit) of the cells.

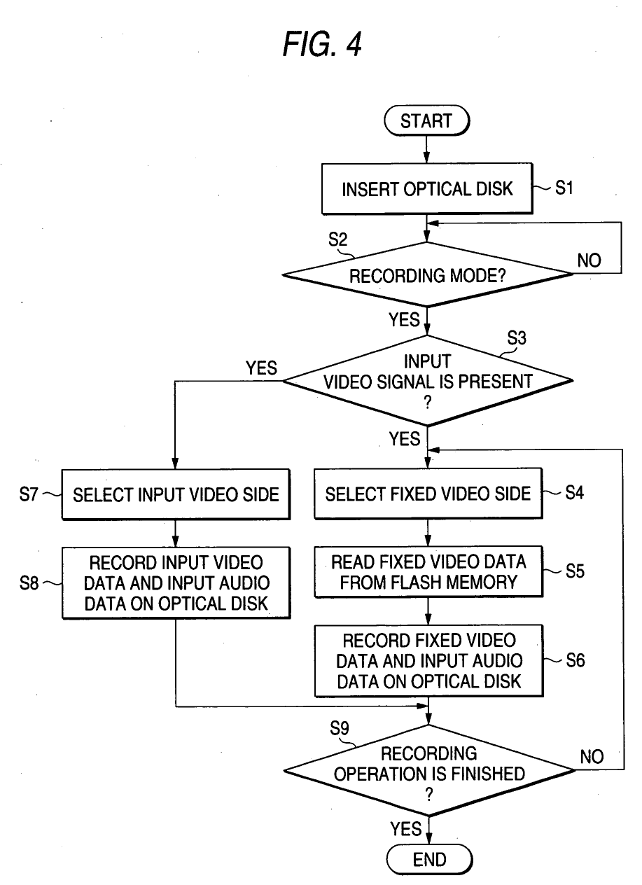

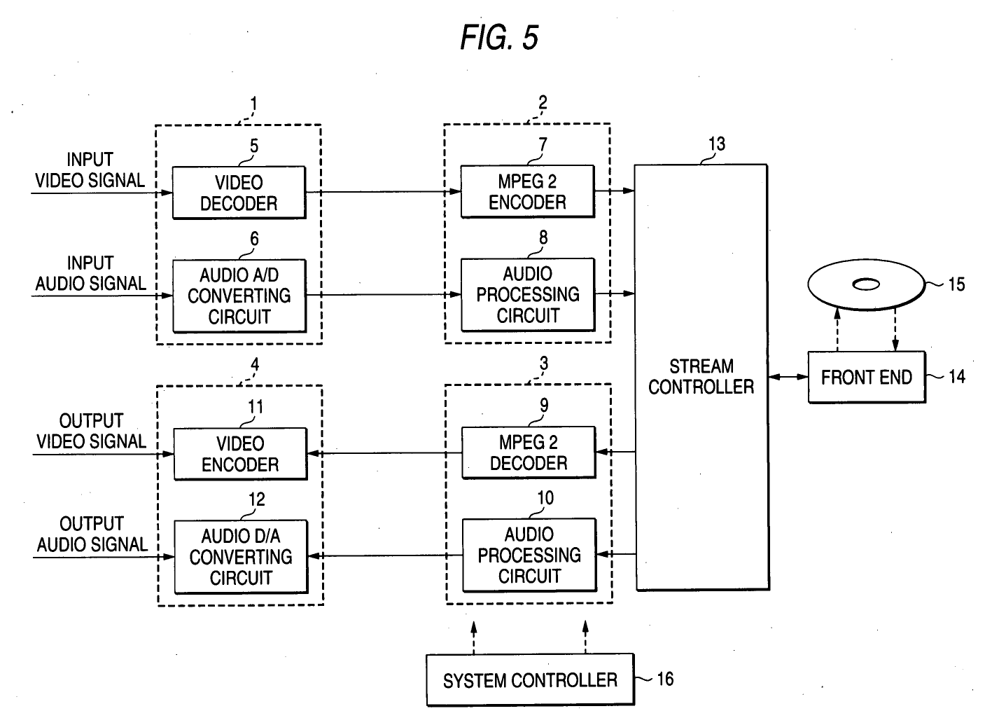

FIG. 4 is a flowchart for explaining a video switching process when video and audio information is recorded on the optical disk in this embodiment. By referring to the flowchart, the video switching process when the video and audio information is recorded on the optical disk will be described.

For instance, the optical disk 15 for recording a television broadcast program is prepared and the optical disk 15 is inserted into the optical disk recording and reproducing apparatus (step S1). Then, when the optical disk recording and reproducing apparatus is set to a recording mode (an image recording mode) (step S2), a video signal and an audio signal of the television broadcast program desired to be recorded are outputted from the tuner (not shown in the drawing) in the optical disk recording and reproducing apparatus or an external output terminal (not shown in the drawing) of a television receiver, and respectively inputted to the video decoder 5 and the audio A/D converting circuit 6.

Here, the signal presence/absence deciding unit 17 of the system controller 16 detects whether or not the input video signal is present in the video decoder 5 (step S3). When the input video signal is present, the system controller 16 drives the switch driving circuit 20. Thus, the switch unit 19 selects an input video side (step S7). That is, the switch unit 19 connects the output end of the video decoder 5 to the input end of the MPEG 2 encoder 7. Accordingly, the digital video signal from the video decoder 5 is inputted to the MPEG 2 encoder 7 and encoded in accordance with the MPEG 2 system. From the MPEG 2 encoder 7, the video data compressed for recording is outputted.

Further, the analog input audio signal is supplied to the audio A/D converting circuit 6 to become the digital audio signal and the digital audio signal is outputted from the audio A/D converting circuit 6. The digital audio signal is inputted to the audio processing circuit 8, buffered and compressed and compressed audio data is outputted from the audio processing circuit 8.

Accordingly, the compressed video data outputted from the MPEG 2 encoder 7 and the compressed audio data outputted from the audio processing circuit 8 become compressed video and audio data through the stream controller 13. The compressed video and audio data is inputted to the front end 14 and recorded on the optical disk 15 in a data form based on the DVD video standard (step S8).

On the other hand, when the signal presence/absence deciding unit 17 of the system controller 16 decides that the input video signal is not present in the video decoder 5 (step S3), the system controller 16 drives the switch driving circuit 20. Thus, the switch driving circuit 20 drives the switch unit 19 to select the fixed video side (step S4). That is, the switch unit 19 is switched to connect the output end of the flash memory 18 to the input end of the MPEG 2 encoder 7.

Thus, the system controller 16 reads the fixed video data (step S5) from the flash memory 18. The read fixed video data is inputted to the MPEG 2 encoder 7 and encoded in accordance with the MPEG 2 system and compressed fixed video data is outputted from the MPEG 2 encoder 7. When a television broadcast is interrupted or an antenna is out of place, the input video signal is not present so that noise appears on a screen. Thus, since when a fixed image is displayed on the screen instead thereof, the noise does not appear, the fixed video data is employed.

Further, when the television broadcast is interrupted or the antenna is out of place, the audio data is desired to be recorded together with the fixed video data. In this case, when an audio signal from other audio device is inputted to the audio A/D converting circuit 6, the fixed video data and the input audio data can be recorded on the optical disk 15 (step S6).

The processes of the above-described steps S3 to S8 are carried out until a recording operation is finished. When the recording operation is finished (step S9), this video switching process is finished.

In the embodiment, when the fixed video data is recorded on the optical disk, if the fixed video data is recorded only in the head VOBU of the cell in accordance with the DVD video standard, the audio data can be recorded for a long time and can be reproduced by a DVD player.

As described above, according to this embodiment, when there is no input video signal upon recording information on the optical disk, the noise image is not recorded and the fixed image can be recorded instead thereof. Accordingly, even when the optical disk is reproduced, the noise image does not appear on a screen so that a user does not have an uneasy feeling. Further, since the fixed video is recorded in accordance with the DVD video standard, the optical disk can be reproduced by the DVD player. When the audio data is set to be recorded on a VOBU except the head VOBU in which the fixed video data is recorded, the optical disk can be used as an optical disk exclusive for audio.

### DRAWINGS

[FIG. 1]

5. video decoder
6. audio A/D converting circuit
7. MPEG 2 encoder
8. audio processing circuit
9. MPEG 2 decoder
10. audio processing circuit
11. video encoder
12. audio D/A converting circuit
13. stream controller
14. front end
16. system controller
17. signal presence/absence deciding unit
18. flash memory
20. switch driving circuit
a. input video signal b. input audio signal c. output video signal d. output audio signal
   [FIG. 4]
S1. Insert optical disk
S2. Recording mode ?
S3. Input video signal is present ?
S4. Select fixed video side.
S5. Read fixed video data from flash memory.
S6. Record fixed video data and input audio data on optical disk.
S7. Select input video side.
S8. Record input video data and input audio data on optical disk.
S9. Recording operation is finished?

What is claimed is:

1. An optical disk recording and reproducing apparatus having: a video decoder for decoding an inputted analog video signal to convert the analog video signal to a digital video signal; and a video encoder for encoding the digital video signal from the video decoder in a prescribed compressing and encoding system and outputting video data compressed for recording to record/reproduce information on an optical disk, said apparatus comprising:
a flash memory previously storing fixed video data;
a switch unit selecting either one of an output of the video decoder and an output of the flash memory, the switch unit inputting the selected output to the video encoder;
a signal presence/absence deciding unit deciding whether or not an input video signal is present upon recording process, and
a switch driving unit driving the switch unit to select the output of the video decoder when the signal presence/absence deciding unit decides that the input video signal is present, and the switching driving unit driving the switch unit to select the output of the flash memory when the signal presence/absence deciding unit decides that the input video signal is not present, wherein the fixed video data from the flash memory is recorded on the optical disk, when the input video signal is not present, and
wherein the fixed video data is recorded only on a VOBU in the head of a cell in accordance with a DVD video standard, when the fixed video data is recorded on the optical disk.

2. An optical disk recording and reproducing apparatus for recording/reproducing information on an optical disk, comprising:
a flash memory previously storing fixed video data;
a switch unit selecting and outputting any of a video signal obtained by processing an input video signal and the fixed video data from the flash memory;
a signal presence/absence deciding unit deciding whether or not the input video signal is present upon recording process, and
a switch driving unit driving the switch unit to select the output of the flash memory when the signal presence/absence deciding unit decides that the input video signal is not present, wherein the fixed video data from the flash memory is recorded on the optical disk, when the input video signal is not present.

3. An optical disk recording and reproducing apparatus according to claim 2, wherein the video signal obtained by processing the input video signal is a digital video signal obtained by decoding an inputted analog video signal by a video decoder, and
wherein a signal outputted from the switch unit is supplied to a video encoder for encoding the digital video signal from the video decoder or the fixed video data from the flash memory in a prescribed compressing and encoding system and outputting video data compressed for recording.

4. An optical disk recording and reproducing apparatus according to claim 2, wherein when the fixed video data is recorded on the optical disk, the fixed video data is recorded only on a VOBU in a head of a cell in accordance with a DVD video standard.
